(19) United States
(12) Patent Application Publication
(10) Pub. No.: US 2026/0014481 A1
(43) Pub. Date: Jan. 15, 2026

(54) SERVER TICK RATE

(71) Applicant: Tencent Technology (Shenzhen) Company Limited, Shenzhen (CN)

(72) Inventors: Yibo WANG, Shenzhen (CN); Zhongcun YAO, Shenzhen (CN)

(73) Assignee: Tencent Technology (Shenzhen) Company Limited, Shenzhen, GD (CN)

(21) Appl. No.: 19/334,544

(22) Filed: Sep. 19, 2025

Related U.S. Application Data
(63) Continuation of application No. PCT/CN2024/088215, filed on Apr. 17, 2024.

(30) Foreign Application Priority Data
Jun. 15, 2023 (CN) 202310714876.1

(51) Int. Cl. A63F 13/77; A63F 13/48; A63F 13/49; A63F 13/52; A63F 13/69; A63F 13/798; A63F 13/837

(52) U.S. Cl. CPC A63F 13/77; A63F 13/52; A63F 13/69; A63F 13/798; A63F 13/48; A63F 13/49; A63F 13/837

(57) ABSTRACT

In a data processing method, based on a client entering a game session of a game application, a game mode of the game session is obtained. A reference server tick rate corresponding to the game mode is determined. Current feature information of the game session is obtained. A current game stage of the game session is determined based on the current feature information. A target server tick rate corresponding to the current game stage is determined based on the current game stage and the reference server tick rate. Game data between a server and the client is refreshed based on the target server tick rate. Apparatus and non-transitory computer-readable storage medium counterpart embodiments are also contemplated.

### RELATED APPLICATIONS

The present application is a continuation of International Application No. PCT/CN2024/088215, filed on Apr. 17, 2024, which claims priority to Chinese Patent Application No. 202310714876.1, filed on Jun. 15, 2023, which are incorporated herein by reference in their entirety.

### FIELD OF THE TECHNOLOGY

This application relates to the field of computer technologies, including to a data processing method and apparatus, an electronic device, a computer program product, and a computer-readable storage medium.

### BACKGROUND OF THE DISCLOSURE

In shooting games, players are often engaged in high-frequency firefight scenarios, and therefore need to maintain a frame rate at a relatively high level. Such games do not restrict a server tick rate, and a single round is usually completed at a fixed frequency, which also places more pressure on a server.

However, because game resources, game modes, player styles, or the like are different, distribution of game intensity in each round of a game is often uneven. This feature depends greatly on game styles of different players. Therefore, no matter whether a relatively high frame rate or a relatively low frame rate is used in the whole battle, and it is difficult to achieve a balance between player experience and server load.

### SUMMARY

Embodiments of this disclosure provide a data processing method and apparatus, an electronic device, a computer program product, and a computer-readable storage medium, so as to allocate a corresponding reference tick rate based on a game mode and dynamically adjust a server tick rate in a game battle.

Technical solutions in the embodiments of this disclosure include the following.

An embodiment of this disclosure provides a data processing method. In the data processing method, based on a client entering a game session of a game application, a game mode of the game session is obtained. A reference server tick rate corresponding to the game mode is determined. Current feature information of the game session is obtained. A current game stage of the game session is determined based on the current feature information. A target server tick rate corresponding to the current game stage is determined based on the current game stage and the reference server tick rate. Game data between a server and the client is refreshed based on the target server tick rate.

An embodiment of this disclosure provides a data processing apparatus, the apparatus including processing circuitry that is configured to obtain, based on a client entering a game session of a game application, a game mode of the game session. The processing circuitry is configured to determine a reference server tick rate corresponding to the game mode. The processing circuitry is configured to obtain current feature information of the game session. The processing circuitry is configured to determine a current game stage of the game session based on the current feature information. The processing circuitry is configured to determine a target server tick rate corresponding to the current game stage based on the current game stage and the reference server tick rate. The processing circuitry is configured to refresh game data between a server and the client based on the target server tick rate.

An embodiment of this disclosure provides a data processing method, applied to an electronic device, the method including: obtaining, in response to a client entering a game battle, a game mode of the current game battle, and determining a reference tick rate corresponding to the game mode; obtaining current battle feature information of the game battle, and determining a current battle stage of the game battle based on the current battle feature information; determining a target tick rate corresponding to the current battle stage based on the current battle stage and the reference tick rate; and refreshing game data between a server and the client based on the target tick rate.

An embodiment of this disclosure provides a data processing apparatus, the apparatus including: a first determination module, configured to obtain, in response to a client entering a game battle, a game mode of the current game battle, and determine a reference tick rate corresponding to the game mode; a second determination module, configured to obtain current battle feature information of the game battle, and determine a current battle stage of the game battle based on the current battle feature information; a third determination module, configured to determine a target tick rate corresponding to the current battle stage based on the current battle stage and the reference tick rate; and a data refresh module, configured to refresh game data between a server and the client based on the target tick rate.

An embodiment of this disclosure provides an electronic device. The electronic device includes: a memory, configured to store a computer-executable instruction; and a processor, configured to implement the data processing method provided in the embodiments of this disclosure when executing the computer-executable instruction stored in the memory.

An embodiment of this disclosure provides a non-transitory computer-readable storage medium storing instructions which, when executed by a processor, cause the processor to implement the data processing method provided in the embodiments of this disclosure.

An embodiment of this disclosure provides a computer program product, including a computer-executable instruction or a computer program, the computer-executable instruction or the computer program, when executed by a processor, implementing the data processing method provided in the embodiments of this disclosure.

Embodiments of this disclosure have the following beneficial effects. On the one hand, a corresponding reference tick rate is configured for each game mode, and after a game battle starts, a reference tick rate of the current game battle is obtained based on the game mode of the game battle, thereby providing a reference standard for normal operation of a game. On the other hand, the reference tick rate is dynamically adjusted based on battle feature information in a game battle, so as to determine target tick rates of the game in different battle stages, which can further reduce load and consumption of the server while ensuring gaming experience of a player, thereby achieving a balance between server performance optimization and player experience improvement.

### BRIEF DESCRIPTION OF THE DRAWINGS

FIG. 1 is a schematic diagram of an architecture of a data processing system according to an embodiment of this disclosure.

FIG. 2 is a schematic structural diagram of a server according to an embodiment of this disclosure.

FIG. 3A is a schematic flowchart of a data processing method according to an embodiment of this disclosure.

FIG. 3B is a schematic diagram of an implementation flow of determining a reference tick rate corresponding to a game mode according to an embodiment of this disclosure.

FIG. 3C is a schematic diagram of another implementation flow of determining a reference tick rate corresponding to a game mode according to an embodiment of this disclosure.

FIG. 3D is a schematic diagram of yet another implementation flow of determining a reference tick rate corresponding to a game mode according to an embodiment of this disclosure.

FIG. 3E is a schematic diagram of an implementation flow of determining a target tick rate corresponding to a current battle stage based on the current battle stage and a reference tick rate according to an embodiment of this disclosure.

FIG. 4 is a schematic diagram of a processing flow of a data processing method according to an embodiment of this disclosure applied to a shooting game.

### DESCRIPTION OF EMBODIMENTS

To make objectives, technical solutions, and advantages of this disclosure clearer, this disclosure is to be further described with reference to the accompany drawings. The described embodiments are not to be construed as a limitation on this disclosure. Other embodiments are within the scope of this disclosure.

In the following description, the involved expression “some embodiments” describes subsets of all possible embodiments, but the expression “some embodiments” may be the same subset or different subsets of all the possible embodiments, and may be combined with each other without conflict.

In the following description, a term “first/second/third” involved is merely configured for distinguishing between similar objects and does not represent a specific order of objects. “First/second/third” may be transposed for a specific order or a sequence when allowed, so that the embodiments of this disclosure described herein can be implemented in an order other than those illustrated or described herein.

In the embodiments of this disclosure, a term “module” or “unit” refers to a computer program or a part of the computer program that has a predetermined function and operates together with another relevant part to achieve a predetermined goal, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in the embodiments of this disclosure are the same as those usually understood by a person skilled in the technical field. Terms used in the embodiments of this disclosure are merely intended to describe the objectives of the embodiments of this disclosure, and are not intended to limit this disclosure.

Examples of terms involved in the embodiments of the disclosure are briefly introduced. The descriptions of the terms are provided as examples only and are not intended to limit the scope of the disclosure.
1) Unreal Engine 4 (UE4): It is a game engine. The engine is mainly designed for development of a first-person shooting game, but has been successfully applied to development of a plurality of different types of games such as a stealth game, a fighting game, and a role play game.
2) Dedicated server (DS): The DS, as a server of the UE4 game, functions to make various decisions in the UE4 game, including all master control states, processing client connection, transferring to a new map, processing an overall game process when a match starts/ends, and the like, which is an important part of a UE4 multiplayer game.
3) Dedicated server agent (DSA): The DSA is a proxy server of the DS, and functions to manage the DS on the server, and serves as a bridge between the DS and another game logic service.
4) Tick rate: It may also be referred to as a “server tick rate”, “server frame rate”, “DS tick rate”, “DS frame rate”, “frame rate”, or the like, which is a quantity of polling executions performed by a server per second, for example, a quantity of times the server receives and calculates game operation data transmitted by a player client per second, or a frequency at which the server uses client information to update data.
5) A game mode refers to different gameplay or game rules designed in a video game, which may allow a player to experience different game manners and challenges. Different game modes usually bring different gaming experience and fun to the player. The following are some common game modes:
(I) Single player mode: A player plays a game alone, and competes against an artificial intelligence (AI) opponent or a fixed environment in the game. The player may complete the game alone based on a plot or a task of the game.
(II) Cooperative multiplayer mode: A player cooperates with other players to jointly resolve a problem or complete a task in a game. The players need to cooperate and assist each other to win the game.
(III) Competitive multiplayer mode: A player competes against other players, and an outcome is obtained through competition. Such a mode usually includes a competitive game (such as a shooting game and a fighting game) and a racing game.
(IV) Survival mode: A player needs to survive in a hostile environment, which usually requires resource management, fighting enemies, and maintaining health points. The survival mode usually tests endurance, strategic ability, and reaction ability of a player.
(V) Time attack mode: A player needs to complete a particular task or challenge within a specified time, usually with a goal of defeating opponents or reaching the finish line as soon as possible.

Different game modes may provide the player with diversified gaming experience, and satisfy preferences and requirements of different player groups. The player may select a suitable game mode based on interest of the player to enjoy the game.
6) Reference tick rate is a standard or recommended tick rate that is set to ensure normal operation and user experience. In the field of games, the reference tick rate may refer to a reference quantity of times of polling performed by a game engine or a server per second. The reference tick rate is a reference standard, which is configured for ensuring that a game application can run at a predetermined performance level. It may help a developer optimize code, or may be used as an important indicator of user experience quality.

In the related art, one game has fewer game modes, and server load is relatively consistent in different game modes. Server tick rates (DS frame rates) in different game modes are usually not configured separately, and frame rates in a single round of the game are not flexibly adjusted, but the whole round of the game is maintained at a stable data refresh level. For example, in shooting games, players are often engaged in high-frequency firefight scenarios, and therefore need to maintain a frame rate at a relatively high level. Such games do not restrict a server tick rate, and a single round is usually completed at a fixed frequency, which also places more pressure on a server.

However, due to differences in map resources, game modes, player game styles, and the like, a player quantity, a player density, a resource density, and the like are inconsistent in each round of the game, and intensity of the game is unevenly distributed in different game stages of one round of the game. Therefore, no matter whether a relatively high frame rate or a relatively low frame rate is used in the whole battle, it is difficult to achieve a balance between player experience and server load.

Embodiments of this disclosure provide a data processing method and apparatus, an electronic device, a computer program product, and a computer-readable storage medium, so that a server tick rate can be dynamically adjusted based on a game mode and a real-time battle status, and in a game battle, adjustment is performed in real time based on a game battle status, to better utilize server resources. An example application of the electronic device provided in the embodiments of this disclosure is described below. The electronic device provided in the embodiments of this disclosure may be implemented as a server. The server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and AI platform. An example application in which the electronic device is implemented as a server is described below.

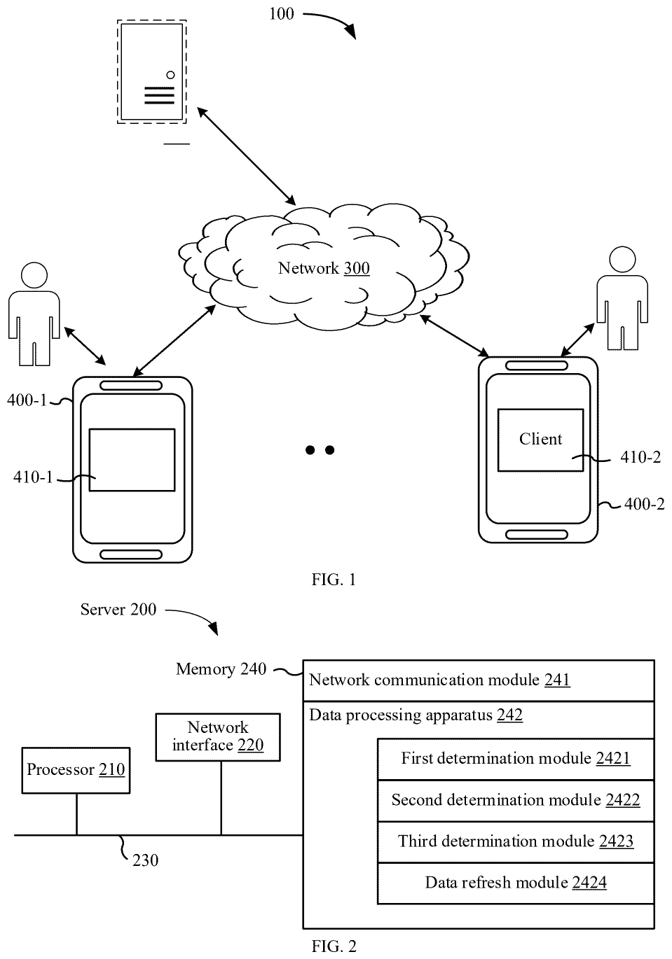

FIG. 1 is a schematic diagram of an architecture of a data processing system 100 according to an embodiment of this disclosure. An example in which the data processing method is applied to a game application is used for description in this embodiment of this disclosure. In this embodiment of this disclosure, a data processing system 100 includes at least a server 200, a network 300, and a terminal (a terminal 400-1 and a terminal 400-2 are shown as examples). The server 200 may be a DS, and the server 200 may constitute the electronic device in this embodiment of this disclosure.

The terminal is connected to the server 200 through the network 300. The network 300 may be a wide area network, a local area network, or a combination thereof. A client (a client 410-1 on the terminal 400-1 and a client 410-2 on the terminal 400-2 are shown as examples) runs on each terminal. For example, a game client, namely, a game library client, is another terminal relative to a game server and running on the server 200. The server serves the game database, and may be responsible for game logic, data transfer, and the like. The client is a game data client, and may be responsible for display, operation, and the like of a game. In this embodiment of this disclosure, one or more clients in one round of a game respectively enter a game battle in response to a player operation. The server 200 obtains, in response to each client entering a game battle, a game mode of the current game battle, and determines a reference tick rate corresponding to the game mode; obtains current battle feature information of the game battle, and determines a current battle stage of the game battle based on the current battle feature information; determines a target tick rate corresponding to the current battle stage based on the current battle stage and the reference tick rate; and refreshes game data between a server and the client based on the target tick rate.

In some embodiments, the server 200 may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a CDN, and a big data and AI platform. The terminal may be a smart phone, a tablet computer, a notebook computer, a desktop computer, a smart speaker, a smart watch, an on-board terminal, or the like, which is not limited thereto. The terminal and the server may be directly or indirectly connected in a manner of wired or wireless communication, which is not limited in the embodiments of this disclosure.

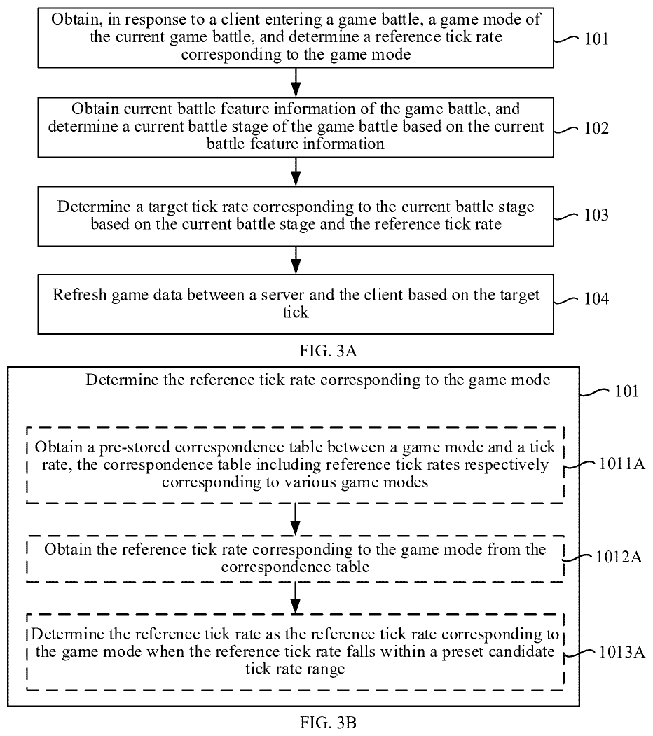

FIG. 2 is a schematic structural diagram of a server 200 according to an embodiment of this disclosure. The server 200 shown in FIG. 2 includes processing circuitry, such as at least one processor 210, a memory 240, and at least one network interface 220. Various components in the electronic device are coupled together through a bus system 230. The bus system 230 is configured to implement connection and communication between the components. In addition to a data bus, the bus system 230 further includes a power bus, a control bus, and a status signal bus. However, for clarity, various buses are marked as the bus system 230 in FIG. 2.

Processing circuitry, such as the processor 210 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The memory 240 may be removable, non-removable, or a combination thereof. An example hardware device includes a solid-state memory, a hard disk driver, an optical disk driver, and the like. In some embodiments, the memory 240 includes one or more storage devices that are physically located away from the processor 210. The memory 240 includes a volatile memory or a non-volatile memory, or may include both the volatile memory and the non-volatile memory. The non-volatile memory may be a read-only memory (ROM). The volatile memory may be a random access memory (RAM). The memory 240 described in this embodiment of this disclosure is intended to include any suitable type of memory. In some embodiments, the memory 240 can store data to support various operations. Examples of the data include a program, a module, and a data structure, or a subset or a superset thereof. An example description is provided below.

A network communication module 241 is configured to arrive at another electronic device through one or more (wired or wireless) network interfaces 220. Examples of network interfaces 220 include a Bluetooth interface, a Wi-Fi interface, a universal serial bus (USB) interface, and the like.

In some embodiments, a data processing apparatus provided in the embodiments of this disclosure may be implemented by software. FIG. 2 shows a data processing apparatus 242 stored in the memory 240, which may be software in the form of programs and plug-ins, including the following software modules: a first determination module 2421, a second determination module 2422, a third determination module 2423, and a data refresh module 2424. The modules are logical and therefore may be arbitrarily combined or further split based on implemented functions. Functions of the modules are described below.

In some embodiments, the apparatus provided in the embodiments of this disclosure may be implemented by hardware. In an example, the apparatus provided in the embodiments of this disclosure may be a processor in the form of a hardware decoding processor, which is programmed to perform the data processing method provided in the embodiments of this disclosure. For example, the processor in the form of the hardware decoding processor may use one or more application specific integrated circuits (ASICs), a DSP, a PLD, a complex PLD (CPLD), a field-programmable gate array (FPGA), or another electronic element.

In some embodiments, the server may implement the data processing method provided in the embodiments of this disclosure by running various computer-executable instructions or computer programs. For example, the computer-executable instructions may be microprogram-level commands, machine instructions, or software instructions. In conclusion, the foregoing computer-executable instruction may be an instruction in any form, and the foregoing computer program may be an APP, a module, or a plug-in in any form.

The data processing method provided in the embodiments of this disclosure is described below. As described above, the electronic device that implements the data processing method of the embodiments of this disclosure may be a server. Therefore, an execution subject of each operation is not repeatedly described below.

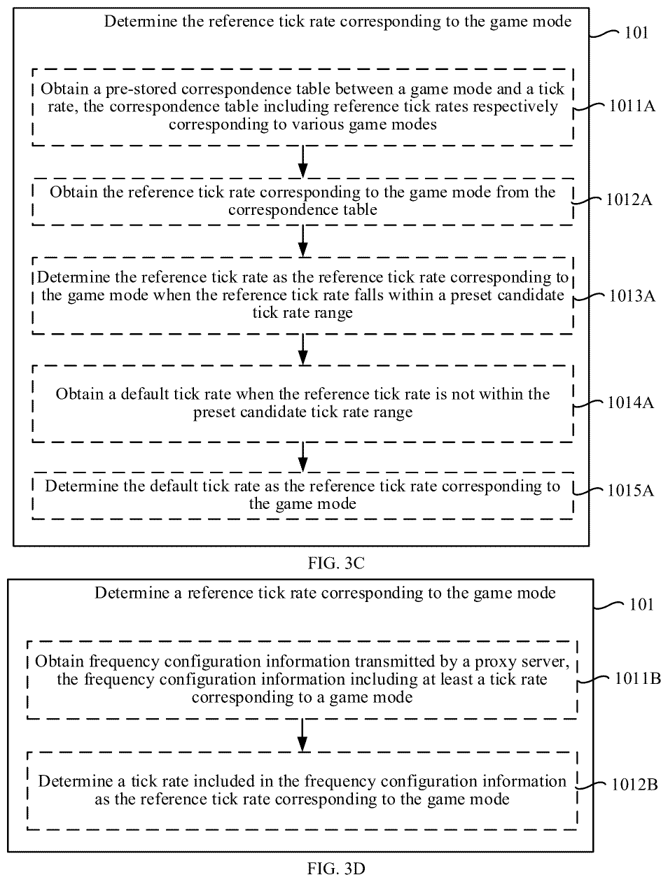

FIG. 3A is a schematic flowchart of a data processing method according to an embodiment of this disclosure. A description is provided based on operations shown in FIG. 3A.

Operation 101: Obtain, in response to a client entering a game battle, a game mode of the game battle, and determine a reference tick rate corresponding to the game mode. In an example, based on a client entering a game session of a game application, a game mode of the game session is obtained. A reference server tick rate corresponding to the game mode is determined.

As an example of operation 101, the obtaining a game mode of the game battle may include: determining, by the server, a game mode of the current game battle based on a connection request transmitted by the client, the connection request being at least configured for establishing a data connection between the server and the client. For example, the client transmits a connection request to the server in response to a player operation of starting a game battle. The connection request may include game mode information, for example, identification information of a game mode. The server determines the game mode of the current game battle based on the game mode information in the connection request in response to the connection request, and transmits game information of the current game battle to the client, for example, a game map. The client loads the game based on the game information for the player to operate.

In this embodiment of this disclosure, after the client enters the game battle in response to the player operation, the server (or the DS) obtains a game mode of the current game battle. The game mode refers to a mode that a player can select in a game. These modes may be, for example, single player, multiplayer, or multiplayer online, or may be a challenge, a competition, or an informal game. The game mode is usually closely related to a game design or game mechanics, and allows a player to perform unique and interactive experience in a game. For example, game modes may be divided based on gameplay, and different game modes provide different gameplay for a player, such as a training mode, a competition mode, a single-player mode, or a multiplayer mode. Alternatively, game modes may be divided based on game scenes. For example, the game may be divided into different game modes based on a map such as a farm, a valley, a mountain area, or a stronghold designed for the game, and different game maps all have different tactical styles. A game mode is an important factor in gaming experience, and the player may select a most suitable mode from different game modes to better enjoy the game.

In the embodiments of this disclosure, a tick rate may also be referred to as a “server frame rate”, “frame rate”, or “DS frame rate”, and refers to a server polling frequency. For example, the server polls 60 times per second. To be specific, the server receives and processes game data transmitted by the client 60 times per second.

The server tick rate does not directly affect experience of the player on the client. In most cases, the player may not perceive whether the server tick rate is high or low. When a fighting scene is encountered, for example, in a shooting game, a process in which the player peeks out from behind cover to fire a shot: after a player A is behind cover, a player B is located in the center of the room, and the player A peeks out from behind cover at this time. This process or action can be embodied in the client of the player B through the following process: a client of the player A transmits a peeking instruction, the server executes the peeking instruction, and the server transmits the behavior to a client of the player B. The server tick rate affects a period of time in this process between a time when the server receives an instruction and a time when the server synchronizes the instruction to another client. A higher tick rate indicates a shorter time required. By increasing the tick rate, a period of time from a time when the player A inputs an instruction of peeking to a time when the player B sees an action of peeking of the player A may be reduced, thereby reducing a data delay and improving player experience.

In short, a DS having a high tick rate can provide experience with a lower delay for a player. However, in addition, a high frame rate DS also means higher overheads of a central processing unit (CPU). In the data processing solution of the embodiments of this disclosure, a balance is achieved between the tick rate and time to find tick rate settings suitable for different modes and different stages of the game.

In some embodiments, the game application may provide a plurality of game modes for the player to select, and each game mode may have unique identification information, for example, mode encoding, to distinguish between different game modes selected by the player.

In some embodiments, the determining a reference tick rate corresponding to the game mode in operation 101 may include: determining, by the server, the reference tick rate corresponding to the game mode of the current game battle based on pre-obtained association relationships between each game mode and the reference tick rate. The association relationship may be determined based on a server load or a battle intensity corresponding to the game mode. In some embodiments, the association relationship may include identification information corresponding to each game mode and a reference tick rate corresponding to each identification information.

As an example, the reference tick rate may include a first reference tick rate and a second reference tick rate. The first reference tick rate is lower than the second reference tick rate. The association relationship may include each game mode corresponding to a first type of mode and the first reference tick rate, and each game mode corresponding to a second type of mode and the second reference tick rate. The first type of mode may be for example a game mode in which a server load requirement is higher than that of the second type of mode, or the first type of mode may be a game mode in which game intensity is higher than that of the second type of mode.

For example, game modes may be divided into the first type of mode and the second type of mode based on a basic mode type of the game, an access permission threshold, a player level, mode particularity, or the like. For example, when game modes are divided into a first type of mode and a second type of mode based on the basic mode type of a single round of a game, for example, the first type of mode may be a novice mode. The novice mode generally supports only one team entering the game, a scene in which strong teams fight usually does not occur in a game battle, and intensity of the game is relatively low. The first type of mode may be set to adopt a relatively low first reference tick rate. The second type of mode may be an expert mode. The expert mode may support at least two teams entering the game, an intense conflict may occur in a game battle, and the second type of mode may be set to adopt a second reference tick rate greater than the first reference tick rate. When game modes are divided into a first type of mode and a second type of mode based on settings of the access permission threshold, the game modes may be divided into a first type of mode in which value of equipment to be provided needs to be less than a first value threshold, or value of a material to be carried needs to be less than a second value threshold, and a second type of mode in which value of equipment to be provided needs to be greater than a first value threshold, or value of a material to be carried needs to be greater than a second value threshold. For example, in some game modes, value of the equipment to be provided needs to meet a certain requirement (in other words, the value of equipment to be provided is greater than the first value threshold), or a specified high-value material (in other words, the value of the carried material is greater than the second value threshold) needs to be carried. Due to the designed access permission mechanism, the game intensity is higher than that in a conventional mode, and a requirement of a player for gaming experience also changes accordingly. Therefore, a reference tick rate of this type of mode (namely, the second type of mode) may be set to the second reference tick rate. When the game modes are divided into the first type of mode and the second type of mode based on the player level, a game mode in which an average player rank is less than or equal to a rank threshold may be classified as the first type of mode, and a game mode in which the average player rank is greater than the rank threshold may be classified as the second type of mode. For the second type of mode designed exclusively for high-tier players, for example, a high-tier round in a game, the players exhibit more sensitivity to game delay, perform more complex operations, and have higher requirements for server tick rates. Therefore, the second type of mode may be set to adopt the second reference tick rate. In addition, for some special game modes, for example, a certain game mode supports coexistence of a plurality of players and a plurality of AI players, which has a relatively large load on a server. To ensure normal progress of a single round of a game, the game mode may be set to adopt the first reference tick rate.

The first type of mode or the second type of mode in this embodiment may include a plurality of specific game modes. For example, the first type of mode may include each game mode corresponding to the novice mode, each game mode in which no requirement or a relatively low requirement is imposed for a threshold for access permission of a player, or each game mode in which a player level is relatively low. The second type of mode may include each game mode corresponding to a non-novice mode, each game mode in which a relatively high requirement is imposed for a threshold for access permission of a player, each game mode in which a player level is relatively high, and each game mode in which multiple players and multiple artificial intelligence (AI) players exist at the same time. In a case that the reference tick rate may include the first reference tick rate and the second reference tick rate, the first type of mode is only configured for referring to all game modes in which the first reference tick rate is used, the second type of mode is only configured for referring to all game modes in which the second reference tick rate is used, and so on. When the reference tick rate may include at least two tick rates, a corresponding game mode may also be divided into at least two types of modes, and each type of mode may include a plurality of specific game modes.

In some embodiments, referring to FIG. 3B, operation 101 of “determining the reference tick rate corresponding to the game mode” shown in FIG. 3A may be implemented through the following operation 1011A to operation 1013A, which are described in detail below.

In operation 1011A, a pre-stored correspondence table between the game mode and a tick rate is obtained, the correspondence table including reference tick rates respectively corresponding to various game modes.

In some embodiments, the server obtains a pre-stored correspondence table, and reference tick rates respectively corresponding to various game modes in the correspondence table may be determined in advance based on a server load or a battle intensity corresponding to each game mode. The server load may be estimated or determined through statistics based on test data of the game mode, and the battle intensity may be determined based on design expectations of the game mode.

As an example, the reference tick rate may include a first reference tick rate and a second reference tick rate. The first reference tick rate is lower than the second reference tick rate. In some embodiments, in the correspondence table, if a server load corresponding to a game mode is higher than a first preset threshold, a reference tick rate corresponding to the game mode is a first reference tick rate, and if the server load corresponding to the game mode is lower than or equal to the first preset threshold, the reference tick rate corresponding to the game mode is a second reference tick rate, the first preset threshold being a server load threshold. Alternatively, if a battle intensity corresponding to a game mode is higher than a second preset threshold, the reference tick rate corresponding to the game mode is a second reference tick rate, and if the battle intensity corresponding to the game mode is lower than or equal to the second preset threshold, the reference tick rate corresponding to the game mode is a first reference tick rate, the second preset threshold being a battle intensity threshold.

For example, in the correspondence table, a reference tick rate of each game mode corresponding to a novice mode, an access permission threshold having no requirement or a relatively low requirement, or a low player level is a first reference tick rate, and a reference tick rate of each game mode corresponding to a non-novice mode, an access permission threshold having a relatively high requirement, a relatively high player level, or support for multiple players and multiple AI players is a second reference tick rate.

In some embodiments, the correspondence table may include identification information respectively corresponding to a plurality of game modes and reference tick rates corresponding to the identification information. In some embodiments, the identification information may be for example mode encoding.

In operation 1012A, the reference tick rate corresponding to the game mode of the game battle is obtained from the correspondence table.

Through operation 1011A and operation 1012A, in this embodiment of this disclosure, a suitable reference tick rate may be configured for a different game mode, thereby implementing reasonable configuration of server resources. In addition, when a player enters a game battle through a client, the server may quickly determine a reference tick rate based on a game mode of the game battle started by the player, thereby improving data processing efficiency.

In operation 1013A, the reference tick rate is determined as the reference tick rate corresponding to the game mode when the reference tick rate falls within a preset candidate tick rate range.

In this embodiment, the candidate tick rate range is a safe frame rate range for ensuring operation of a game, and is configured for performing a safety check on the reference tick rate in the correspondence table. The candidate tick rate range may be a continuous numerical value interval. For example, the candidate tick rate range may be [30, 120]. If the reference tick rate is within the numerical value interval of [30, 120], assuming that the reference tick rate is 75, the reference tick rate is determined as the reference tick rate corresponding to the game mode. In some embodiments, the candidate tick rate range may further be a numerical value set including a plurality of discrete numerical values. For example, the candidate tick rate range may be {30, 60, 90, 120}. Assuming that the reference tick rate is 75, it is determined in this case that the reference tick rate is not within the candidate tick rate range.

In some embodiments, the candidate tick rate range may be obtained in advance based on stress test data.

Through operation 1013A, the corresponding reference tick rate is configured based on the reference tick rate in the correspondence table only when the reference tick rate in the correspondence table is within the candidate tick rate range, which reduces a probability of a runtime error.

In some embodiments, referring to FIG. 3C, after operation 1013A shown in FIG. 3B, operation 1014A to operation 1015A may further be performed, which are described in detail below.

In operation 1014A, a default tick rate is obtained when the reference tick rate is not within the preset candidate tick rate range.

The default tick rate is a pre-configured tick rate that may ensure normal operation of the game. In some embodiments, the default tick rate may be predetermined based on stress test data. For example, the default tick rate may be 60 times per second.

In operation 1015A, the default tick rate is determined as the reference tick rate corresponding to the game mode.

Through operation 1014A and operation 1015A, when the reference tick rate in the correspondence table is not within the candidate tick rate range, the corresponding reference tick rate is configured based on the default tick rate, to prevent a game runtime error caused by malicious tampering of the correspondence table.

In some embodiments, referring to FIG. 3D, operation 101 of “determining the reference tick rate corresponding to the game mode” shown in FIG. 3A may be implemented through the following operation 1011B to operation 1012B, which are described in detail below.

In operation 1011B, frequency configuration information transmitted by a proxy server is obtained, the frequency configuration information including at least a tick rate corresponding to the game mode.

In this embodiment, a server obtains the frequency configuration information transmitted by the proxy server. The proxy server is configured to manage each DS on the server, and may transmit the frequency configuration information to the DS, to configure a tick rate of the DS through a startup parameter of the DS when the DS is started.

In some embodiments, the frequency configuration information includes at least identification information corresponding to the game mode and a tick rate corresponding to the game mode. The identification information may be, for example, mode encoding.

In operation 1012B, the tick rate included in the frequency configuration information is determined as the reference tick rate corresponding to the game mode.

In some embodiments, when the reference tick rate corresponding to the game mode obtained from the correspondence table through operation 1012A is inconsistent with the tick rate corresponding to the game mode included in the frequency configuration information obtained through operation 1011B, the tick rate corresponding to the game mode included in the frequency configuration information is determined as the reference tick rate corresponding to the game mode.

As an example of operation 1012B, when the tick rate corresponding to the game mode included in the frequency configuration information is within a preset candidate tick rate range, the tick rate included in the frequency configuration information is determined as the reference tick rate corresponding to the game mode. When the tick rate corresponding to the game mode included in the frequency configuration information is not within the preset candidate tick rate range, a default tick rate is obtained, and the default tick rate is determined as the reference tick rate corresponding to the game mode.

Through operation 1011B and operation 1012B, in this embodiment, for a problem that a correspondence table needs to be pre-stored and does not have timeliness, if a tick rate of a certain game mode needs to be immediately changed in case of emergency, the frequency configuration information transmitted by the proxy server may be adopted, and a reference tick rate of the game mode is specified in a form of a server startup parameter, so that a configuration manner is more flexible.

Still referring to FIG. 3A, a description is continued with operation 102 above.

In operation 102, current battle feature information of the game battle is obtained, and a current battle stage of the game battle is determined based on the current battle feature information. In an example, current feature information of the game session is obtained. A current game stage of the game session is determined based on the current feature information.

In this embodiment, the current battle feature information may be feature information of each battle stage determined based on game design logic, and may be configured for reflecting a game battle stage. For example, for a shooting game, in a game stage before a battle is started, a game map needs to be loaded first, and a player is waited for to enter the map. Battle feature information of the stage may include information representing resource loading, a player having not entered the map, or the like. In a game battle, after loading of all player resources is completed, the game formally starts, and battle feature information of the stage may include information representing completion of resource loading, a player having entered a map, or the like. In a game cleanup stage after a battle is completed, when all players exit and no player is present in the map, battle feature information of the stage may include information representing that a quantity of players in the battle is zero, or the like.

In some embodiments, the current battle feature information of the game battle may be obtained based on interaction data between a server and a client in a game running process, and operation 102 may be implemented in the following manner. The server receives a data request transmitted by the client, the data request being configured for requesting game data, and a current battle stage of a game battle is determined based on the data request, for example, being configured for requesting to establish a connection to load a game resource or requesting a map data packet. In this case, the server may determine that the current battle stage is a game stage before a battle starts. Alternatively, the server receives a data packet transmitted by the client. The data packet may include operation information of a player. A current battle stage of the game battle is determined based on the data packet. For example, the data packet may include operation information of a player entering a map, and in this case, the server may determine that the current battle stage is a game stage in progress of a battle. Alternatively, the data packet includes operation information of a player exiting a game, and in this case, the server may determine that the current battle stage is a game stage in which the battle is completed.

In some embodiments, the current battle feature information includes at least current battle status flag information, and operation 102 of determining the current battle stage of the game battle based on the current battle feature information may include: determining that the current battle stage of the game battle is a first battle stage when the current battle status flag information is first flag information representing that the game battle does not start; determining that the current battle stage of the game battle is a second battle stage when the current battle status flag information is second flag information representing that the game battle is in progress; and determining that the current battle stage of the game battle is a third battle stage when the current battle status flag information is third flag information representing that the game battle ends.

As an example, the first flag information is configured for representing that a game battle is in a first battle stage, for example, may include information representing loading of a game resource or a player having not entered a game map. The second flag information is configured for representing that the game battle is in a second battle stage, for example, may include information representing completion of loading of a game resource or a player having entered a game map. The third flag information is configured for representing that the game battle is in the third battle stage, for example, may include information representing that all players have exited the game map, and initiation of game cleanup.

Through operation 102, in this embodiment, battle stages of a single round of a game are reasonably divided, so as to configure different server tick rates for different battle stages, thereby implementing optimization of server performance and improvement of player experience.

Still referring to FIG. 3A, a description is continued with operation 103 above.

In operation 103, a target tick rate corresponding to the current battle stage is determined based on the current battle stage and the reference tick rate. A target server tick rate corresponding to the current game stage is determined based on the current game stage and the reference server tick rate.

In this embodiment of this disclosure, the server may adjust the reference tick rate based on a battle stage, to determine the target tick rate corresponding to a different battle stage of a game battle, thereby flexibly adjusting a server tick rate in the game battle, to implement the optimization of server performance and improvement of player experience.

In some embodiments, referring to FIG. 3E, operation 103 shown in FIG. 3A may be implemented through the following operation 1031 to operation 1033, which are described in detail below.

In operation 1031, when the current battle stage is the first battle stage or the third battle stage, a product of a first proportionality coefficient and the reference tick rate is determined as the target tick rate corresponding to the current battle stage, the first proportionality coefficient being a real number greater than 0 and less than 1.

In this embodiment, the first battle stage is a game stage before a battle starts, and the third battle stage is a game stage after the battle ends. The first proportionality coefficient is configured for reducing a server tick rate of the first battle stage or the third battle stage based on a reference tick rate, and the first proportionality coefficient may be preset.

In some embodiments, the first proportionality coefficient corresponding to the first battle stage may be the same as or different from the first proportionality coefficient corresponding to the third battle stage.

In operation 1032, battle attribute information is obtained when the current battle stage is the second battle stage.

In this embodiment of this disclosure, the second battle stage is a game stage in which a player is performing a battle. The battle attribute information may be configured for representing a battle status of a player, and may include information that affects a server load and/or game intensity in the game battle, for example, may include information such as a quantity of players, a quantity of player teams, whether players fight, a player equipment attribute, a player level, and a player rank.

In some embodiments, the server may obtain battle attribute information based on a data packet transmitted by each client in one game battle. For example, a quantity of players and a quantity of player teams are determined based on a quantity of clients transmitting the data packet, and it is determined, based on player operation information in the data packet, whether players fight.

In operation 1033, the target tick rate corresponding to the current battle stage is determined based on the reference tick rate and the battle attribute information.

In this embodiment of this disclosure, the server adjusts the reference tick rate based on the battle attribute information, to obtain the target tick rate corresponding to the current battle stage.

Through operation 1031 to operation 1033, in this embodiment, a corresponding server tick rate is configured for a different battle stage based on the divided battle stages in a game battle, and a balance is achieved between gaming experience of a player and server load, thereby implementing server performance optimization while ensuring gaming experience of the player.

In some embodiments, operation 1033 may include: determining the target tick rate based on a second proportionality coefficient and the reference tick rate when the quantity of teams is less than a preset quantity threshold, the second proportionality coefficient being a real number greater than 0 and less than 1; and determining the reference tick rate as the target tick rate when the quantity of teams is greater than or equal to the quantity threshold.

In this embodiment, the second proportionality coefficient is configured for reducing the server tick rate of the second battle stage based on the reference tick rate, and the second proportionality coefficient may be preset. The second battle stage is a game stage in which a player is performing a battle. In the second battle stage, it is determined that the game has entered an endgame or a low-intensity state only when a quantity of player teams is less than a preset quantity threshold, and a server tick rate is reduced. The reference tick rate is adopted in all other cases.

In some embodiments, the determining the target tick rate based on a second proportionality coefficient and the reference tick rate may include: determining a product of the second proportionality coefficient and the reference tick rate as the target tick rate.

In some embodiments, the second proportionality coefficient may be the same as or different from the first proportionality coefficient.

As an example, the battle attribute information may further include player rank information, and the determining the target tick rate based on a second proportionality coefficient and the reference tick rate when the quantity of teams is less than a preset quantity threshold may include: obtaining the player rank information when the quantity of teams is less than the preset quantity threshold; determining a product of the second proportionality coefficient and the reference tick rate as the target tick rate when the player rank information is less than a preset rank threshold; and determining the reference tick rate as the target tick rate when the player rank information is higher than or equal to the rank threshold.

In this embodiment, in the second battle stage, in addition to adjustment of the tick rate based on the quantity of player teams, the player rank information is further considered. The server tick rate is reduced based on the second proportionality coefficient only when the quantity of player teams is less than the preset quantity threshold and the player rank information is less than the preset rank threshold. The reference tick rate is adopted in all other cases.

Through operation 1033, in this embodiment, the server flexibly configures server tick rates in different fight situations in the battle based on the battle attribute information while ensuring gaming experience of players in fierce fight, thereby optimizing server performance.

Still referring to FIG. 3A, a description is continued with operation 104 above.

In operation 104, game data between a server and the client is refreshed based on the target tick rate. In an example, game data between a server and the client is refreshed based on the target server tick rate.

The target tick rate in this embodiment of this disclosure is only for the server. The target tick rate can affect game data refresh on the client, but is not configured for specifying a tick rate of game data on a client side.

In some embodiments, the data processing method may further include: obtaining load information of the server at the interval of the preset duration when the target tick rate is the reference tick rate; obtaining a third proportionality coefficient when the load information is greater than a preset load threshold, the third proportionality coefficient being a real number greater than 0 and less than 1; and determining a product of the third proportionality coefficient and the reference tick rate as the target tick rate.

In this embodiment, the third proportionality coefficient is configured for reducing a server tick rate based on the reference tick rate. The third proportionality coefficient may be preset, or may be determined based on the server load information. In this embodiment, in the second battle stage, current server load information may be periodically obtained, and when it is found that the server load exceeds the preset load threshold, the server tick rate is adjusted based on the third proportionality coefficient, thereby achieving a balance between the server load and gaming experience of the player, and reducing load overheads of the server.

In some embodiments, the third proportionality coefficient may be the same as or different from the first proportionality coefficient and the second proportionality coefficient in the foregoing embodiments.

Next, an example application of this embodiment of this disclosure in an actual application scenario is to be described.

In an embodiment of this disclosure, an example in which the data processing method is applied to a shooting game is used for description. The data processing method provided in the embodiments of this disclosure is also applicable to other types of games.

Currently, a server frame rate is not limited in a mainstream shooting game on the market, and a single round is usually completed at a fixed frame rate. For example, in a mainstream conquest mode of Call of Duty Mobile, a dozen players are often at a high firefight frequency, and therefore, a frame rate needs to be maintained at a relatively high level, which also puts more pressure on the server.

For a shooting game developed based on UE4 with a large map, multiple articles, and refinement, in some modes of the game, a small quantity of players exist in a single round, and no intense fight exists. For these modes, the server is always running at a relatively high tick rate, which is a waste of server resources, and the distribution of the intensity of the game in the Arena Breakout is uneven. The feature greatly depends on game styles of different players. Therefore, no matter whether a relatively high frame rate or a relatively low frame rate is used in the whole battle, and it is difficult to achieve a balance between player experience and server load. In addition, a quantity and density of players and a resource density in different maps and different modes are different. The same tick rate used in all modes or in an entire round of a game cannot provide the most efficient service resource allocation for each map and each mode.

Before a processing flow of this example is described, a configuration rule of a basic frame rate (i.e., the reference tick rate in the foregoing embodiment) of the server in this example is first introduced.

In this example, an example in which two basic frame rates may be configured is used. The two basic frame rates of the server are both obtained through stress test data and are safe frame rates that may ensure operation. A high basic frame rate and a low basic frame rate are respectively described below. In this example, various game modes in a game are first distinguished based on game design logic. Each game mode not only includes a unique feature thereof, but also has similarities.

In this example, the configuration rule mainly includes two directions: a server CPU load and game intensity. Generally, a higher CPU load in a game mode indicates that a server frame rate is to be adjusted to a low frame rate to ensure availability. In a game mode with higher game intensity, the server frame rate is to be adjusted to a high frame rate to ensure gaming experience. In this example, a basic frame rate of the server in each game mode is mainly configured based on dimensions such as a basic type of a single round mode, a mode threshold, a player skill level, and a special mode.

For example, it may be determined based on a basic type of a single round mode that some game modes are novice modes. Such modes support only one player team in entering, a scene of a high-intensity fight usually does not occur in the battle, and the game intensity is relatively low. Therefore, a basic frame rate of this novice mode may be set to a low basic frame rate.

It may be determined, based on the mode threshold, that some game modes impose certain requirements on an access permission threshold of a player. For example, value of equipment to be provided needs to meet certain requirements, or a specified high-value material needs to be carried. Due to the access permission mechanism, the game intensity is higher in some modes, and a player has a higher requirement on gaming experience. Therefore, a basic frame rate of this game mode is to be set to a high basic frame rate.

It may be determined, based on the player skill level, that some game modes are high-tier rounds designated by high-tier players. These players have more sensitive experience on a game delay, have more complex operations, and impose higher requirements on a server frame rate. Therefore, a basic frame rate of this game mode is to be set to a high basic frame rate.

It may be determined based on a special mode that some modes have a relatively high requirement on a CPU load. For example, a certain mode supports simultaneous presence of up to 30 players and numerous AI players, and a CPU load is relatively large. To ensure normal progress of a single round of a game, a basic frame rate in this mode is set to a low basic frame rate.

Therefore, the basic frame rate of the server corresponding to each game mode may be determined according to the foregoing configuration rule.

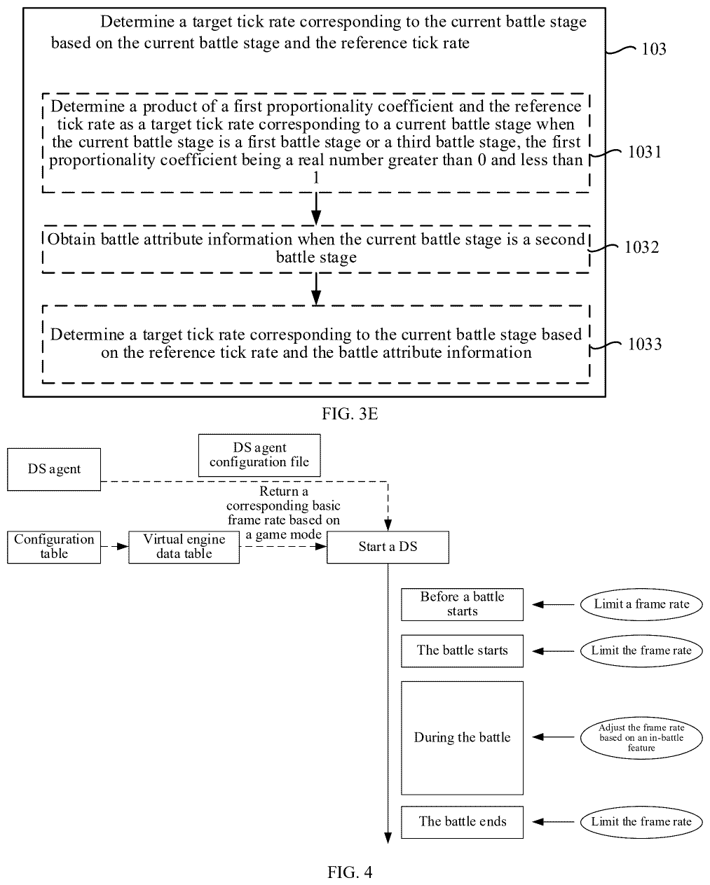

FIG. 4 is a schematic diagram of a processing flow of a data processing method according to an embodiment of this disclosure applied to a shooting game. A description is to be provided based on the processing flow shown in FIG. 4.

Before a DS is started, a basic frame rate of a server is first configured. In this example, the basic frame rate may be configured in two manners, which are respectively described below.

First, a configuration table is adopted. The configuration table records basic frame rates of the DS respectively corresponding to a plurality of game modes determined according to the foregoing configuration rule, for example, mode identification information (mode encoding and the like) corresponding to each game mode and a corresponding basic frame rate of the server. The server may determine a basic frame rate of a server corresponding to an enabled game mode based on the configuration table. Referring to FIG. 4, this manner is essentially converted from a configuration table (for example, an Excel configuration table) into a virtual engine data table (UDataTable) file format that may be directly read by UE4, for example, a pre-stored correspondence table between a game mode and a tick rate in the foregoing embodiment, for the server to read and use.

Due to an attribute of the configuration table, the configuration table may be modified by multiple players. To ensure normal operation of a game, a default frame rate (corresponding to a default tick rate in another embodiment) may be preset. The default frame rate may include a plurality of frame rate options subjected to a stress test. A server frame rate is configured based on the configuration table only when a frame rate in the configuration table belongs to the default frame rate. Otherwise, the server frame rate is configured at the default frame rate, thereby reducing a possibility of occurrence of an error.

In this manner, the configuration table is directly stored in a game program package. During daily use, in case of emergency, a server frame rate in a certain game mode needs to be immediately modified by updating the configuration table. Therefore, the configuration table does not have timeliness.

Second, a startup parameter is adopted. Specifically, a proxy server may modify or configure a configuration file of the proxy server, a serial number of a game mode and a corresponding basic frame rate of the server being specified. When the DS is started based on the configuration file of the proxy server, a startup parameter of the server is directly used to control a running frame rate of the DS. This manner may cover a frame rate configured through a configuration table.

When the startup parameter of the server is not the default frame rate, the parameter is configured based on the default frame rate, to reduce a possibility of occurrence of an error.

After the basic frame rate of the server is configured in the foregoing manner, a corresponding basic frame rate of the server may be determined for each game mode. In other words, different game modes may run at different configured basic frame rates of the server. In addition, after the game starts, in this example, the server frame rate is further dynamically adjusted based on an in-battle feature.

First, two stages in a game battle in which no players fight are considered, namely, a stage before the game battle starts (namely, the foregoing first battle stage) and a stage after the game battle ends (namely, the foregoing third battle stage). Before the game battle starts, just after a server is started, a process of loading a map and waiting for a player to join exists, and the server in the process may run at a basic frame rate. After the game battle ends, no player is in the battle in this case, and the server further needs to perform cleanup for a period of time to exit completely. In this case, the server may also run at the basic frame rate. For a stage in which players fight (i.e., the foregoing second battle stage), when all game resources are loaded completely and a single round of a game formally starts, because birth places of players in the game have certain randomness, a firefight may occur immediately after the game starts. Therefore, the server frame rate needs to be adjusted immediately from below the basic frame rate to the basic frame rate.

In addition, in a game battle, a relatively high frame rate can ensure gaming experience of players in an intense fight. However, for a game in which any player is allowed to freely explore in the battle before the game ends, only one player or a team of players may remain in the game battle for a period of time. Therefore, in the game battle, the server frame rate may further be dynamically adjusted based on the game intensity in the game battle. For example, in a conventional case, the server frame rate remains stable, for example, is maintained at the basic frame rate. However, when a quantity of player teams decreases below a preset quantity threshold (for example, 2), it may be determined that a battle has entered an endgame or a low-intensity state, and the server frame rate may be decreased to below the basic frame rate. In addition, if the quantity of teams increases to or above the preset quantity threshold because a player joins a battle, the frame rate is restored to the basic frame rate.

Based on the foregoing analysis, the server may obtain current battle feature information of the game battle after being started, and determine a current battle stage of the game battle based on the current battle feature information. For example, it may be determined, based on current battle status flag information, that the current battle stage of the game battle is the first battle stage, the second battle stage, or the third battle stage. The current battle status flag information may be, for example, information configured for determining whether to enter each battle stage. For example, the server separately executes the first battle stage of the game based on a first function, a second function, and a third function, so as to determine the current battle stage as the first battle stage when meeting a running condition of the first function, determine the current battle stage as the second battle stage when meeting a running condition of the second function, and determine the current battle stage as the third battle stage when meeting a running condition of the third function.

Referring to FIG. 4, the first battle stage is a stage before the battle starts, and the third battle stage is a stage in which the battle ends. In this case, the server may determine the target frame rate in the first battle stage based on a product of a first proportionality coefficient and the basic frame rate. The first proportionality coefficient is a real number greater than 0 and less than 1, and is configured for limiting the target frame rate to be less than the basic frame rate. The second battle stage is a stage in a battle process. After a battle starts, the DS may immediately restore to the basic frame rate, and in this stage, the frame rate is adjusted based on an in-battle feature (namely, the foregoing battle attribute information). For example, a quantity of teams in the game battle is obtained, and when the quantity of teams is less than a preset quantity threshold, the target frame rate is determined based on a product of a second proportionality coefficient and the basic frame rate, the second proportionality coefficient being a real number greater than 0 and less than 1, to limit the frame rate when it is determined that the game enters an endgame or a low-intensity state. Alternatively, player rank information is obtained. When the quantity of teams is less than a preset quantity threshold and a player team is less than a preset rank threshold, the target frame rate is determined based on the product of the second proportionality coefficient and the basic frame rate. Alternatively, CPU load information (not shown in FIG. 4) of the server may also be periodically obtained. When the load information is greater than a preset load threshold, the target frame rate is determined based on a product of a third proportionality coefficient and the basic frame rate, the third proportionality coefficient being a real number greater than 0 and less than 1.

Therefore, the server may dynamically adjust the server frame rate based on a game mode and a real-time status of a battle, and dynamically adjust the server frame rate in a game battle through flexible configuration, thereby implementing optimization of server performance and improvement of player experience.

An example structure of the data processing apparatus 242 provided in the embodiments of this disclosure implemented as a software module is further described below. In some embodiments, as shown in FIG. 2, software modules in the data processing apparatus 242 stored in the memory 240 may include:
a first determination module 2421, configured to obtain, in response to a client entering a game battle, a game mode of the game battle, and determine a reference tick rate corresponding to the game mode;
a second determination module 2422, configured to obtain current battle feature information of the game battle, and determine a current battle stage of the game battle based on the current battle feature information;
a third determination module 2423, configured to determine a target tick rate corresponding to the current battle stage based on the current battle stage and the reference tick rate; and
a data refresh module 2424, configured to refresh game data between a server and the client based on the target tick rate.

In some embodiments, the first determination module 2421 is further configured to: obtain a pre-stored correspondence table between the game mode and a tick rate, the correspondence table including reference tick rates respectively corresponding to various game modes; obtain the reference tick rate corresponding to the game mode from the correspondence table; and determine the reference tick rate as the reference tick rate corresponding to the game mode when the reference tick rate falls within a preset candidate tick rate range.

In some embodiments, the first determination module 2421 is further configured to obtain a default tick rate when the reference tick rate is not within the preset candidate tick rate range; and determine the default tick rate as the reference tick rate corresponding to the game mode.

In some embodiments, the first determination module 2421 is further configured to obtain frequency configuration information transmitted by a proxy server, the frequency configuration information including at least a tick rate corresponding to the game mode; and determine the tick rate included in the frequency configuration information as the reference tick rate corresponding to the game mode.

In some embodiments, the current battle status information includes at least current battle status flag information. The second determination module 2422 is further configured to: determine that the current battle stage of the game battle is a first battle stage when the current battle status flag information is first flag information representing that the game battle does not start; determine that the current battle stage of the game battle is a second battle stage when the current battle status flag information is second flag information representing that the game battle is in progress; and determine that the current battle stage of the game battle is a third battle stage when the current battle status flag information is third flag information representing that the game battle ends.

In some embodiments, the third determination module 2423 is further configured to: determine a product of a first proportionality coefficient and the reference tick rate as the target tick rate corresponding to the current battle stage when the current battle stage is the first battle stage or the third battle stage, the first proportionality coefficient being a real number greater than 0 and less than 1; obtain battle attribute information when the current battle stage is the second battle stage; and determine the target tick rate corresponding to the current battle stage based on the reference tick rate and the battle attribute information.

In some embodiments, the battle attribute information includes at least a quantity of teams in a game battle. In some embodiments, the third determination module 2423 is further configured to determine the target tick rate based on a second proportionality coefficient and the reference tick rate when the quantity of teams is less than a preset quantity threshold, the second proportionality coefficient being a real number greater than 0 and less than 1; and determine the reference tick rate as the target tick rate when the quantity of teams is greater than or equal to the quantity threshold.

In some embodiments, the battle attribute information further includes player rank information. The third determination module 2423 is further configured to: obtain the player rank information when the quantity of teams is less than the preset quantity threshold; determine a product of the second proportionality coefficient and the reference tick rate as the target tick rate when the player rank information is less than a preset rank threshold; and determine the reference tick rate as the target tick rate when the player rank information is higher than or equal to the rank threshold.

In some embodiments, the data processing apparatus 242 further includes a fourth determination module. The fourth determination module is configured to: obtain load information of the server at the interval of the preset duration when the target tick rate is the reference tick rate; obtain a third proportionality coefficient when the load information is greater than a preset load threshold, the third proportionality coefficient being a real number greater than 0 and less than 1; and determine a product of the third proportionality coefficient and the reference tick rate as the target tick rate.

In some embodiments, the data processing apparatus 242 further includes an attribute obtaining module and a fifth determination module. The attribute obtaining module is configured to obtain battle attribute information again when it is determined that the current battle stage is still the second battle stage after an interval of a preset duration. The fifth determination module is configured to determine the reference tick rate as the target tick rate when the quantity of teams in the battle attribute information is greater than or equal to the quantity threshold.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An embodiment of this disclosure provides a computer program product, the computer program product including a computer-executable instruction or a computer program, the computer-executable instruction or the computer program being stored in a computer-readable storage medium. A processor of an electronic device reads the computer-executable instruction from the computer-readable storage medium. The processor executes the computer-executable instruction, so that the electronic device performs the foregoing data processing method provided in the embodiments of this disclosure.

An embodiment of this disclosure provides a computer-readable storage medium, such as a non-transitory computer-readable storage medium, having a computer-executable instruction or a computer program stored therein, the computer-executable instruction or the computer program, when executed by a processor, causing the processor to perform the data processing method provided in the embodiments of this disclosure, for example, the data processing method shown in FIG. 3A.

In some embodiments, the computer-readable storage medium may be a memory such as a RAM, a ROM, a flash memory, a magnetic surface memory, a compact disc, or a CD-ROM, or may be various devices including one or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

In an example, the computer-executable instruction may be deployed to be executed on one electronic device, or executed on a plurality of electronic devices located at one location, or executed on a plurality of electronic devices distributed at a plurality of locations and connected through a communication network.

Based on the above, according to the embodiments of this disclosure, on the one hand, a corresponding reference tick rate is configured for each game mode, and on the other hand, tick rates of a game in different battle stages are dynamically adjusted based on battle feature information, battle attribute information, and the like in a game battle, which reduces load and consumption of the server and achieving a balance between server performance optimization and player experience improvement while ensuring gaming experience of a player.

The foregoing descriptions are merely some embodiments of this disclosure and are not intended to limit the scope of this disclosure. Any modification, equivalent replacement, or improvement made within the spirit and principle of this disclosure falls within the scope of this disclosure.

What is claimed is:

1. A data processing method, the method comprising:
obtaining, based on a client entering a game session of a game application, a game mode of the game session;
determining a reference server tick rate corresponding to the game mode;
obtaining current feature information of the game session;
determining a current game stage of the game session based on the current feature information;
determining a target server tick rate corresponding to the current game stage based on the current game stage and the reference server tick rate; and
refreshing, by processing circuitry, game data between a server and the client based on the target server tick rate.

2. The method according to claim 1, wherein game states of the game session is updated by the server according to the target server tick rate.

3. The method according to claim 1, wherein the determining the reference server tick rate comprises:
obtaining correspondence information, the correspondence information indicating a plurality of reference server tick rates corresponding to a plurality of game modes;
obtaining the reference server tick rate corresponding to the game mode of the game session from the correspondence information; and
determining the reference server tick rate as the reference server tick rate corresponding to the game mode when the reference server tick rate falls within a candidate server tick rate range.

4. The method according to claim 3, wherein the determining the reference server tick rate comprises:
when the reference server tick rate is not within the candidate server tick rate range,
obtaining a default server tick rate; and
determining the default server tick rate as the reference server tick rate corresponding to the game mode.

5. The method according to claim 1, wherein the determining the reference server tick rate comprises:
obtaining frequency configuration information transmitted by a proxy server, the frequency configuration information including at least a server tick rate corresponding to the game mode; and
determining the server tick rate included in the frequency configuration information as the reference server tick rate corresponding to the game mode.

6. The method according to claim 1, wherein
the current feature information includes at least current game status information; and
the determining the current game stage of the game session comprises:
determining that the current game stage of the game session is a first game stage when the current game status information indicates that the game session is to be started;
determining that the current game stage of the game session is a second game stage when the current game status information indicates that the game session is in progress; and
determining that the current game stage of the game session is a third game stage when the current game status information indicates that the game session ends.

7. The method according to claim 6, wherein the determining the target server tick rate comprises:
determining a product of a first proportionality coefficient and the reference server tick rate as the target server tick rate corresponding to the current game stage when the current game stage is the first game stage or the third game stage, the first proportionality coefficient being a real number greater than 0 and less than 1; and
determining the target server tick rate corresponding to the current game stage based on the reference server tick rate and first session attribute information when the current game stage is the second game stage.

8. The method according to claim 7, wherein
the first session attribute information indicates at least a quantity of teams in the game session; and
the determining the target server tick rate comprises:
determining the target server tick rate based on a second proportionality coefficient and the reference server tick rate when the quantity of teams is less than a quantity threshold, the second proportionality coefficient being a real number greater than 0 and less than 1; and
determining the reference server tick rate as the target server tick rate when the quantity of teams is greater than or equal to the quantity threshold.

9. The method according to claim 8, wherein
the first session attribute information indicates player rank information; and
the determining the target server tick rate comprises:
obtaining the player rank information when the quantity of teams is less than the quantity threshold;
determining a product of the second proportionality coefficient and the reference server tick rate as the target server tick rate when the player rank information is less than a rank threshold; and
determining the reference server tick rate as the target server tick rate when the player rank information is greater than or equal to the rank threshold.

10. The method according to claim 8, further comprising:
obtaining second session attribute information when the current game stage is the second game stage after an interval of a preset duration; and
determining the reference server tick rate as the target server tick rate when the quantity of teams in the second session attribute information is greater than or equal to the quantity threshold.

11. The method according to claim 1, further comprising:
obtaining load information of the server at an interval of a preset duration when the target server tick rate is the reference server tick rate;
obtaining a third proportionality coefficient when the load information is greater than a load threshold, the third proportionality coefficient being a real number greater than 0 and less than 1; and
determining a product of the third proportionality coefficient and the reference server tick rate as the target server tick rate.

12. A data processing apparatus, comprising:
processing circuitry configured to:
obtain, based on a client entering a game session of a game application, a game mode of the game session;
determine a reference server tick rate corresponding to the game mode;
obtain current feature information of the game session;
determine a current game stage of the game session based on the current feature information;
determine a target server tick rate corresponding to the current game stage based on the current game stage and the reference server tick rate; and
refresh game data between a server and the client based on the target server tick rate.

13. The data processing apparatus according to claim 12, wherein game states of the game session is updated by the server according to the target server tick rate.

14. The data processing apparatus according to claim 12, wherein the processing circuitry is configured to:
obtain correspondence information, the correspondence information indicating a plurality of reference server tick rates corresponding to a plurality of game modes;
obtain the reference server tick rate corresponding to the game mode of the game session from the correspondence information; and
determine the reference server tick rate as the reference server tick rate corresponding to the game mode when the reference server tick rate falls within a candidate server tick rate range.

15. The data processing apparatus according to claim 14, wherein the processing circuitry is configured to
when the reference server tick rate is not within the candidate server tick rate range,
obtain a default server tick rate; and
determine the default server tick rate as the reference server tick rate corresponding to the game mode.

16. The data processing apparatus according to claim 12, wherein the processing circuitry is configured to:
obtain frequency configuration information transmitted by a proxy server, the frequency configuration information including at least a server tick rate corresponding to the game mode; and
determine the server tick rate included in the frequency configuration information as the reference server tick rate corresponding to the game mode.

17. The data processing apparatus according to claim 12, wherein
the current feature information includes at least current game status information; and
the processing circuitry is configured to
determine that the current game stage of the game session is a first game stage when the current game status information indicates that the game session is to be started;
determine that the current game stage of the game session is a second game stage when the current game status information indicates that the game session is in progress; and
determine that the current game stage of the game session is a third game stage when the current game status information indicates that the game session ends.

18. The data processing apparatus according to claim 17, wherein the processing circuitry is configured to:
determine a product of a first proportionality coefficient and the reference server tick rate as the target server tick rate corresponding to the current game stage when the current game stage is the first game stage or the third game stage, the first proportionality coefficient being a real number greater than 0 and less than 1; and
determine the target server tick rate corresponding to the current game stage based on the reference server tick rate and first session attribute information when the current game stage is the second game stage.

19. The data processing apparatus according to claim 18, wherein
the first session attribute information indicates at least a quantity of teams in the game session; and
the processing circuitry is configured to:
determine the target server tick rate based on a second proportionality coefficient and the reference server tick rate when the quantity of teams is less than a quantity threshold, the second proportionality coefficient being a real number greater than 0 and less than 1; and
determine the reference server tick rate as the target server tick rate when the quantity of teams is greater than or equal to the quantity threshold.

20. A non-transitory computer-readable storage medium storing instructions which, when executed by a processor, cause the processor to perform:
obtaining, based on a client entering a game session of a game application, a game mode of the game session;
determining a reference server tick rate corresponding to the game mode;
obtaining current feature information of the game session;
determining a current game stage of the game session based on the current feature information;
determining a target server tick rate corresponding to the current game stage based on the current game stage and the reference server tick rate; and
refreshing game data between a server and the client based on the target server tick rate.
